(19) United States
(12) Patent Application Publication
(10) Pub. No.: US 2009/0192646 A1
(43) Pub. Date: Jul. 30, 2009

(54) COMBINED MANAGEMENT SYSTEM

(76) Inventor: Keun-An Song, Seongnam-city (KR)

Correspondence Address: MORGAN, LEWIS & BOCKIUS LLP (SF), One Market, Spear Street Tower, Suite 2800, San Francisco, CA, 94105, US

(21) Appl. No.: 12/045,464

(22) Filed: Mar. 10, 2008

(30) Foreign Application Priority Data
Jan. 28, 2008 (KR) 10-2008-0008531

(51) Int. Cl. G06F 17/00

(52) U.S. Cl. 700/110

(57) ABSTRACT

A combined management system includes: a factory server; at least one terminal in communication with a user, such as a consumer or a specialist; and a central server in communication with the factory server and the terminal, for determining, based on signals received from the factory server, whether a malfunction occurs in a factory, and connecting the terminal with the factory server if a malfunction does occur.

### CROSS-REFERENCE TO RELATED APPLICATION

This application claims priority to, and the benefit of, Korean Patent Application No. 10-2008-0008531, filed in the Korean Intellectual Property Office on Jan. 28, 2008, the entire contents of which are incorporated herein by reference.

### BACKGROUND OF THE INVENTION

(a) Field of the Invention

The present invention relates to a combined management system. More particularly, the present invention relates to such a system that receives information about an operating state of each factory, production and sales volume of goods, and consumer complaints; stores them in a database; and, if a problem occurs, solves the problem quickly by receiving a solution stored in the database, or by receiving a solution directly from a specialist.

(b) Description of the Related Art

Recently, goods manufactured within any one country are sold both in that country and abroad. Further, as overseas markets increase, factories are constructed, and goods manufactured, in foreign countries to curtail shipping expenses and quickly supply goods to consumers in those countries.

Malfunctions of machines or complaints of consumers must be solved quickly, regardless of the location of the factory. Specialists may need to travel great distances or receive detailed information remotely to resolve problems. The travel time of the specialists prevents manpower from being utilized efficiently. Therefore, there is a need for a combined management system that facilitates quick resolution of the problems and efficient management of manpower. In addition, stock and storage space need to be managed efficiently, taking supply and demand into account.

The above information disclosed in this Background section is only for enhancement of understanding of the background of the invention and therefore it may contain information that does not form the prior art that is already known in this country to a person of ordinary skill in the art.

### SUMMARY OF THE INVENTION

A combined management system includes: a factory server; at least one terminal in communication with a user, such as a consumer or a specialist; and a central server in communication with the factory server and the terminal, for determining, based on signals received from the factory server, whether a malfunction occurs in a factory, and connecting the terminal with the factory server if a malfunction does occur.

The system may also include at least one of: a camera for detecting images in the factory, in communication with the factory server; an information sensor for detecting information of components used in the factory, in communication with the factory server; and a malfunction sensor for detecting the malfunction, in communication with the factory server.

The central server may include a malfunction diagnosis database, with causes, states, and solutions of possible malfunctions being stored in the malfunction diagnosis database.

Each of the components may be associated with an identifier, such as a bar code, and the information sensor may detect the identifiers.

A malfunction may be determined if the location of one of the components does not change for a predetermined time.

The central server may output the solution to the malfunction stored in the malfunction diagnosis database to the factory server, if the cause and the state of the malfunction are stored in the malfunction diagnosis database.

The central server may receive input from the specialist through the terminal, and output the input to the factory server, if the cause and the state of malfunction of the machines are not stored in the malfunction diagnosis database.

The terminal may be able to receive complaints from a consumer.

The central server may also include a complaint database. The complaints, and solutions to the complaints, are stored in the complaint database.

The central server may output the solutions stored in the complaint database to the terminal, if the complaints of the consumer are stored in the complaint database.

The central server may receive solutions to the complaints through another terminal, in communication with the specialist, and output the solutions to the terminal that is accessible to the consumer, if the complaints of the consumer are not stored in the complaint database.

The central server may also include at least one of: a production database for storing information about production of goods in the factory and stock of components used in the factory; a sales database for storing information about sales volume of the goods; and a transport database for storing information about transport states of the goods and/or the components.

### BRIEF DESCRIPTION OF THE DRAWINGS

FIG. 1 is a block diagram of a combined management system according to an exemplary embodiment of the present invention.

FIG. 2 is a block diagram of a factory server according to an exemplary embodiment of the present invention.

FIG. 3 is a block diagram of a central server according to an exemplary embodiment of the present invention.

FIG. 4 shows one example of a model of a product line in a factory according to an exemplary embodiment of the present invention.

FIG. 5 is a block diagram of a terminal according to an exemplary embodiment of the present invention.

FIG. 6 is a flowchart showing processes of resolving malfunctions according to an exemplary embodiment of the present invention.

FIG. 7 is a flowchart showing processes of responding to complaints of consumers according to an exemplary embodiment of the present invention.

### DETAILED DESCRIPTION OF PREFERRED EMBODIMENTS

An exemplary embodiment of the present invention will hereinafter be described in detail with reference to the accompanying drawings.

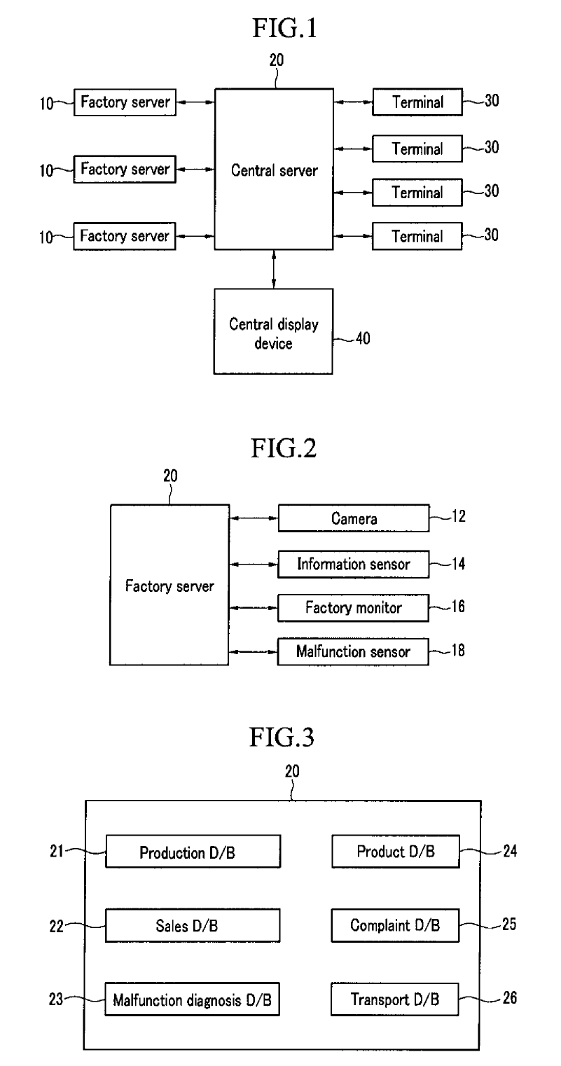

As shown in FIG. 1, a combined management system according to an exemplary embodiment of the present invention includes a plurality of factory servers 10 installed in respective factories; a central server 20 connected to the factory servers 10; a plurality of terminals 30 receiving information from dealers, consumers, and specialists, and transmitting the information to the central server 20; and a central display device 40, receiving information analyzed by the central server 20, and displaying the information.

As shown in FIG. 2, each factory server 10 is in communication with a camera 12, an information sensor 14, a factory monitor 16, and a malfunction sensor 18. The factory server 10 detects images of product lines in the factory and information on each component used in the factory, judges malfunction of the machines used in the factory, and transmits signals corresponding thereto to the central server 20.

The camera 12 may include one or more fixed cameras and/or movable cameras. The fixed cameras 12 are installed at each machine in the factory, and the movable cameras 12 are installed between the machines. The cameras 12 can rotate in order to detect images of machines at various angles. The cameras 12 detect the images of the product line in the factory and transmit the images to the factory server 10. In addition, operation of the cameras 12 can be controlled by the central server 20. Therefore, in a case in which a machine is out of order, an image of the machine is detected at various angles by control of the central server 20 and is transmitted to the central server 20.

The information sensor 14 detects information of each component used in the factory and transmits signals corresponding thereto to the factory server 10. Each component has an identifier associated with it, and the information sensor 14 detects the identifiers and transmits signals corresponding to the type, identification number, and location of the components in the product line to the factory server 10. The identifiers may be, for example, bar codes or IDs, and the information sensor 14 may be an optical mark reader.

The factory monitor 16 displays information and orders received from the central server 20, as well as images received from the cameras 12. Therefore, workers in the factory can resolve problems or machine malfunctions that occur in the factory, according to the information and orders displayed on the factory monitor 16.

The malfunction sensor 18 detects malfunctions of the machines in the factory and transmits signals corresponding thereto to the factory server 10. The malfunction sensor 18 includes various sensors corresponding to types of the machines. For example, a malfunction sensor 18 mounted at a painting machine may include a pressure sensor for detecting the pressure of the paint, a temperature sensor for detecting the temperature of the paint, and a position sensor for detecting movement of goods.

As shown in FIG. 3, the central server 20 includes a production database 21, a sales database 22, a malfunction diagnosis database 23, a product database 24, a complaint database 25, and a transport database 26.

Real-time production of goods and the real-time total stock of each component are stored in the production database 21. That is, after the information sensor 14 detects the identifiers associated with each component and transmits signals corresponding thereto to the central server 20, the central server 20 checks the components used at a final assembling machine in the product line of the factory such that the real-time production of goods is stored automatically in the production database 21. In addition, the central server 20 determines the number of each component that is not used in the product line of the factory such that the real-time total stock is stored automatically in the production database 21. In addition, the central server 20 analyzes the total stock of each component stored in the production database 21 and orders a manufacturing factory of an under supplied component to increase production. In addition, the central server 20 organizes the production of goods and the total stock of each component stored in the production database 21 into a user-readable format, such as a table or graph, and displays the table or the graph at the central display device 40.

Real-time sales volume of goods received from the terminal 30 of each dealer is stored in the sales database 22. The sales volume is classified and stored in the sales database 22 according to type, region, and date of the sale. The central server 20 organizes the sales volume stored in the sales database 22 into a user-readable format, such as a table or graph, and displays the table or the graph at the central display device 40. In addition, the central server 20 compares the production of goods stored in the production database 21 with the sales volume of goods stored in the sales database 22 in order to calculate the total stock of goods, and orders the factory server 10 to control operations of the factories based on the total stock of goods.

Cause, state, and solution of malfunctions that occur in each factory are stored in the malfunction diagnosis database 23. The malfunction diagnosis database 23 determines whether a malfunction occurs in each factory and, if a malfunction occurs, outputs a solution to the malfunction to the factory server 10. In addition, the product line in the factory is modeled in the malfunction diagnosis database 23.

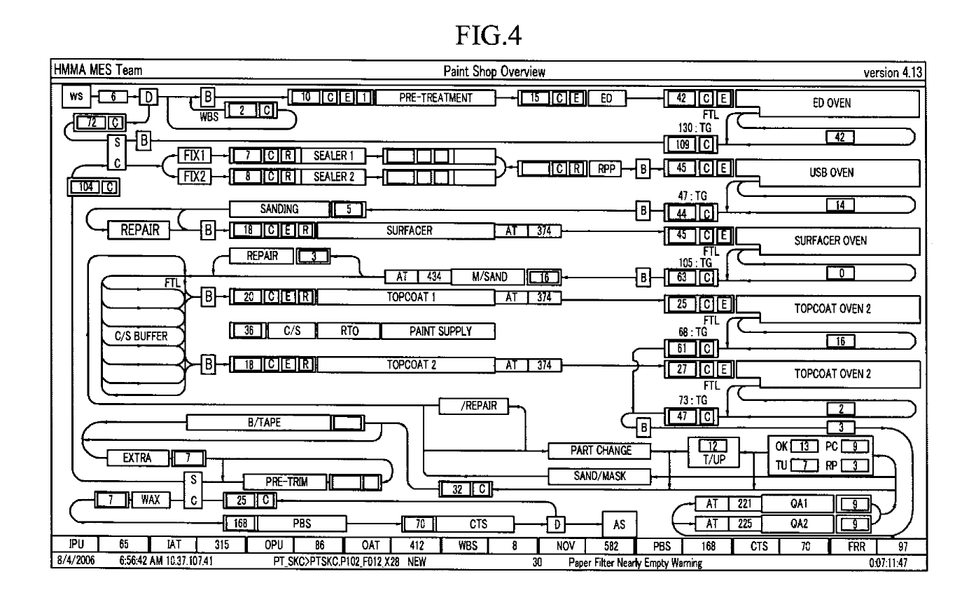

As shown in FIG. 4, the product line in the factory may be modeled as a two-dimensional plane figure. In FIG. 4, a box represents a machine, a number written in the box represents the identifier of a component that is loaded at the machine, and a line represents a transferring device such as a conveyor belt. Based on the model, a malfunctioning part can be quickly detected. In addition, since images of the malfunctioning part can be detected in real time by using one of the cameras 12 that is near the malfunction part, specialists located in other regions can resolve the malfunction.

Further, the malfunction diagnosis database 23 determines malfunction of the product line if the location of each component displayed on the model of the product line does not change for a predetermined time, or if the malfunction diagnosis database 23 receives a signal corresponding to the malfunction of the machines from the malfunction sensor 18. If the product line is out of order, the central server 20 receives information about the malfunction of the machine from the malfunction sensor 18 and analyzes the malfunction.

Referring back to FIG. 3, detailed information about the goods produced in each factory is stored in the product database 24.

Complaints from consumers and solutions to the complaints are stored in the complaint database 25. That is, if consumers input complaints through the terminal 30, the central server 20 determines whether the complaints have been stored in the complaint database 25. If the complaints have not been stored in the complaint database 25, the complaints are then stored in the complaint database 25. Thereafter, the complaint database 25 receives solutions to the complaints through the terminal 30 that is accessible to the specialists, and outputs the solutions to the terminal 30 that is accessible to the consumers.

Current transport conditions of goods and components are stored in the transport database 26. If goods are transferred to a dealer or components are transferred to the factory, the mode of transport is stored. In addition, since identifiers are associated with each transport, location of each transport is detected, such as by a satellite, and is stored in the transport database 26. Therefore, time in which goods are delivered to consumers, and components manufactured, is managed efficiently.

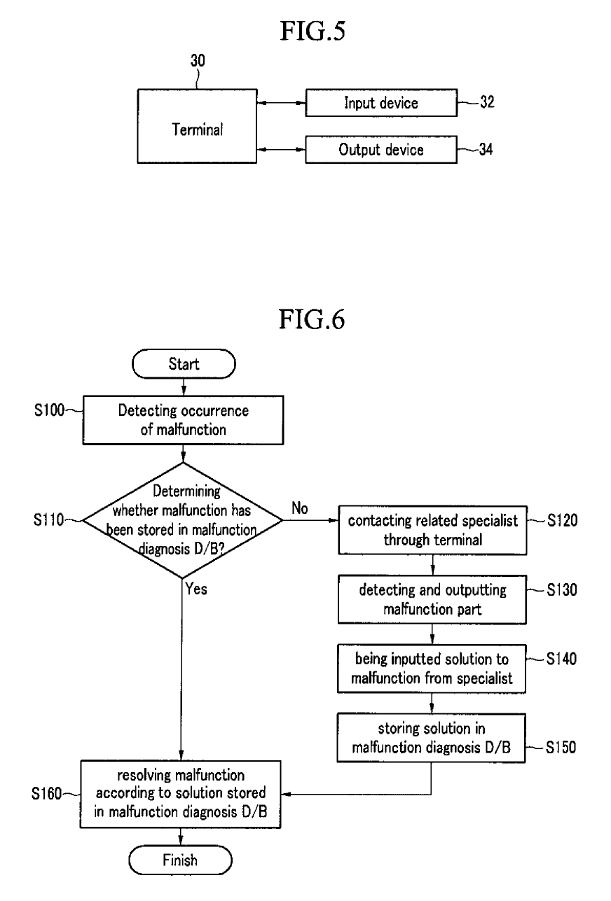

As shown in FIG. 5, each terminal 30 may be accessible to specialists, dealers, and/or consumers. The specialists input solutions to malfunctions or to consumer complaints through the terminal 30. Dealers input sales volumes of goods, and necessary goods, through the terminal 30. Consumers input complaints through the terminal 30. As described above, information inputted through the terminals 30 is transmitted to the central server 20 and is stored in the appropriate database 21, 22, 23, 24, 25, or 26.

Each terminal 30 is associated with an input device 32 for receiving solutions, sales volumes, and complaints, and an output device 34 for outputting information, such as by displaying images of the malfunctioning part in the factory, and solutions to consumer complaints.

The central display device 40 (FIG. 1) may include a plurality of monitors, such as cube type monitors configured to facilitate constitution of multi-screens. Therefore, much information may be displayed at each screen or at all screens.

Hereinafter, processes of resolving malfunctions by using a combined management system according to an exemplary embodiment of the present invention will be described in detail.

As shown in FIG. 6, in a case in which the malfunction diagnosis database 23 detects occurrence of a malfunction at step S100, the central server 20 determines whether the malfunction has been stored in the malfunction diagnosis database 23 at step S110. As described above, the location of each component on the model of the product line not changing for a predetermined time, or the malfunction diagnosis database 23 receiving a signal corresponding to the malfunction of the machines from the malfunction sensor 18, may be criteria in detecting an occurrence of malfunction. The predetermined time may be, for example, 10 to 20 minutes.

If the type of malfunction has already been stored in the malfunction diagnosis database 23 at step S110, the central server 20 outputs a solution to the malfunction, stored in the malfunction diagnosis database 23, to the factory server 10, and receives resolving information of the malfunction in real time at step S160.

If the type of malfunction has not yet been stored in the malfunction diagnosis database 23 at step S110, the central server 20 contacts a related specialist through the terminal 30 that is accessible to the related specialist at step S120. Information, such as the image of the malfunction detected by the cameras 12, and operation of the machine detected by the malfunction sensor 18, are transmitted to the specialist at the output device 34 of the appropriate terminal 30 at step S130, and the specialist determines a cause and solution of the malfunction based on information from the output device 34. After that, the specialist inputs the solution of the malfunction through the input device 32 at step S140, and the cause, state, and solution of the malfunction are stored in the malfunction diagnosis database 23 at step S150.

After that, the central server 20 outputs the solution of the malfunction, stored in the malfunction diagnosis database 23, to the factory server 10, and receives resolving information of the malfunction in real time at step S160.

As described above, since a remote specialist sees the malfunction by using the cameras 12, and inputs the solution to the malfunction to the factory server 10 in real time, problems may be resolved quickly and precisely.

For example, if a vehicle body is dropped from a bogie, a specialist in a different country can see a photograph of the malfunctioning part through the output device 34 of the terminal 30 in real time, and input advice through the input device 32, such as that a ring for attaching the body is needed. Thereafter, the specialist can oversee the process of mounting the ring for attaching the body to the bogie and input advice. Then, the specialist checks that the bogie moves safely. The problem is thus resolved quickly and precisely.

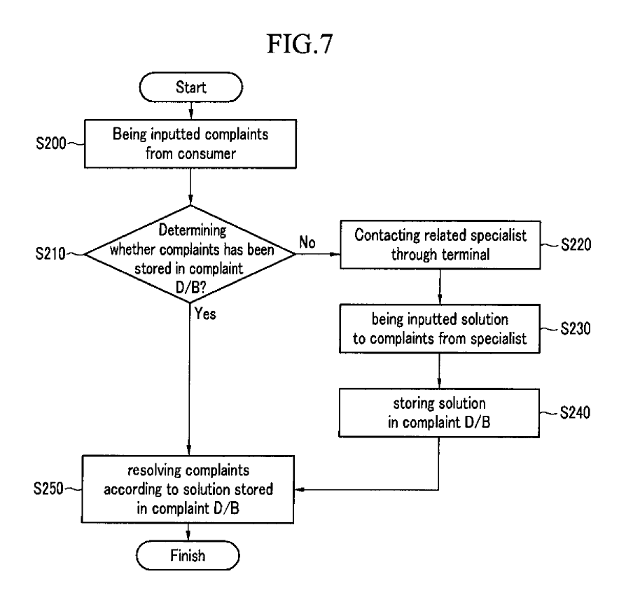

As shown in FIG. 7, if a consumer inputs complaints through the terminal 30, the complaints are transmitted to the complaint database 25 at step S200. The central server 20 determines whether the complaints have already been stored in the complaint database 25 at step S210.

If the complaints have already been stored in the complaint database 25 at step S210, the central server 20 outputs solutions to the complaints to the output device 34 of the terminal 30, receives resolving information of the complaints in real time, and checks whether other complaints are inputted at step S250.

If the complaints have not yet been stored in the complaint database 25 at step S210, the central server 20 contacts a related specialist through the terminal 30 that is accessible to the related specialist at step S220. The complaints of the consumer and, if needed, images relevant to the complaints, are displayed at the output device 34 of the terminal 30 that is accessible to the specialist, and the specialist determines a cause and solution of the complaints based on information displayed at the output device 34. The specialist then inputs solutions to the complaints through the input device 32 at step S230, and causes and solutions of the complaints are stored in the complaint database 25 at step S240.

After that, the central server 20 outputs the solution of the complaints stored in the complaint database 25 to the output device 34 of the terminal 30, receives resolving information of the complaints in real time, and checks whether other complaints are inputted at step S250.

As described above, since a remote specialist sees and resolves the complaints in real time, the complaints are resolved quickly and precisely. Therefore, customer satisfaction may increase.

According to the exemplary embodiments described herein, if problems are already stored in a database, solutions to the problems are outputted. If the problems are not already stored in the database, specialists directly input the solutions to the problems. Thus, the problems may be resolved quickly and manpower may be efficiently managed. In addition, the total stock and components of goods may be efficiently managed. Further, since complaints of consumers are quickly and precisely solved, customer satisfaction may increase.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A combined management system comprising:
a factory server;
at least one terminal configured to communicate with a user; and
a central server in communication with the factory server and the terminal, and configured to determine, based on signals received from the factory server, whether a malfunction occurs in a factory, and connecting the terminal with the factory server if the malfunction does occur.

2. The combined management system of claim 1, further comprising a member selected from the group consisting of: a camera for detecting images in the factory, in communication with the factory server; an information sensor for detecting information of components used in the factory, in communication with the factory server; a malfunction sensor for detecting the malfunction, in communication with the factory server; and combinations thereof.

3. The combined management system of claim 1, wherein the central server comprises a malfunction diagnosis database, wherein causes, states, and solutions of possible malfunctions are stored in the malfunction diagnosis database.

4. The combined management system of claim 2, wherein each of the components is associated with an identifier, and the information sensor detects the identifiers.

5. The combined management system of claim 4, wherein the identifier comprises a bar code.

6. The combined management system of claim 2, wherein a malfunction is determined if a location of one of the components does not change for a predetermined time.

7. The combined management system of claim 3, wherein the central server outputs the solution to the malfunction stored in the malfunction diagnosis database to the factory server if the cause and the state of the malfunction are stored in the malfunction diagnosis database.

8. The combined management system of claim 3, wherein the central server receives input from the user through the terminal and outputs the input to the factory server if the cause and the state of malfunction of the machines are not stored in the malfunction diagnosis database.

9. The combined management system of claim 1, wherein the terminal can receive complaints from a consumer.

10. The combined management system of claim 9, wherein the central server further comprises a complaint database, wherein the complaints, and solutions to the complaints, are stored in the complaint database.

11. The combined management system of claim 10, wherein the central server outputs the solutions stored in the complaint database to the terminal if the complaints of the consumer are stored in the complaint database.

12. The combined management system of claim 10, wherein the central server receives solutions to the complaints through another terminal and outputs the solutions to the terminal that is accessible to the consumer if the complaints of the consumer are not stored in the complaint database.

13. The combined management system of claim 1, wherein the central server further comprises a member selected from the group consisting of: a production database for storing information about production of goods in the factory and stock of components used in the factory; a sales database for storing information about sales volume of the goods; a transport database for storing information about transport states of the goods and/or the components; and combinations thereof.
